(19) United States
(12) Patent Application Publication
(10) Pub. No.: US 2026/0062503 A1
(43) Pub. Date: Mar. 5, 2026

(54) METHOD FOR PRODUCING THERMOPLASTIC MOULDING COMPOUNDS

(71) Applicant: INEOS STYROLUTION GROUP GMBH, Frankfurt am Main (DE)

(72) Inventors: Wolfgang FISCHER, Heidelberg (DE); Koen TAELMAN, Brsschaat (BE)

(21) Appl. No.: 19/103,667

(22) PCT Filed: Aug. 16, 2023
(86) PCT No.: PCT/EP2023/072544

§ 371 Date: Feb. 13, 2025

(30) Foreign Application Priority Data
Aug. 18, 2022 (EP) 22190939.3

(51) Int. Cl. C08C 1/14; C08C 3/02; C08L 51/04

(52) U.S. Cl. CPC C08C 1/14; C08C 3/02; C08L 51/04

(57) ABSTRACT

The invention relates to a method for producing thermoplastic moulding compounds (73), said method comprising: (a) feeding a dispersion (1), that contains a rubber, and a precipitation solution (3) into a precipitation tank (5), an aqueous suspension (9) that contains rubber particles being produced; (b) optionally sintering the rubber particles contained in the aqueous suspension (9) that contains rubber particles to form larger particles; (c) mechanically dewatering the aqueous suspension that contains rubber particles, rubber particles (33) that contain residual moisture and a liquid phase (35) that contains fine-particle rubber being obtained; (d) feeding the rubber particles (33) that contain residual moisture into an extruder (57), the extruder (57) comprising a drawing-in zone (55), a dewatering section (59), at least one feed section (65) for at least one further polymer (67) and/or additives, a mixing section (69), and a discharge zone (71), the liquid phase that contains residual rubber separated in the dewatering section (59) being collected in a buffer tank (63), the buffer tank (63) comprising at least one agitator (75); and returning the liquid phase (77) that contains residual rubber collected in the buffer tank (63) to the precipitation tank (5).

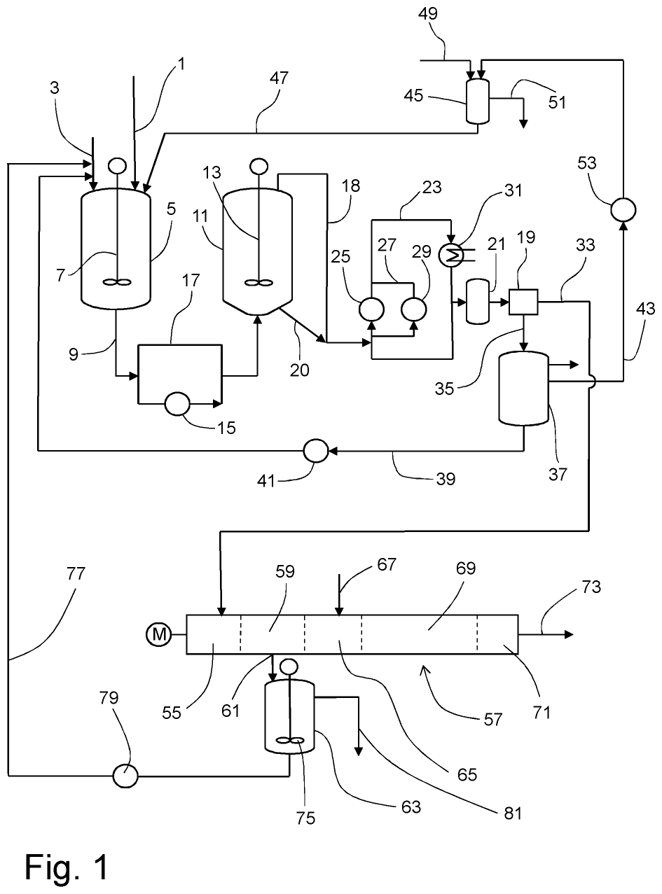

The invention relates to a process for producing thermoplastic molding compounds, comprising:
(a) feeding a dispersion containing a rubber and also a precipitation solution into a precipitation vessel, to generate an aqueous suspension containing rubber particles,
(b) optionally sintering the rubber particles present in the aqueous suspension containing rubber particles, to give larger particles,
(c) mechanically dewatering the aqueous suspension containing rubber particles, to obtain rubber particles containing residual moisture and a liquid phase containing finely divided rubber,
(d) feeding the rubber particles containing residual moisture into an extruder, the extruder comprising an intake zone, into which the rubber particles containing residual moisture are fed; a dewatering section, in which a liquid phase containing residual rubber is removed from the rubber particles containing residual moisture; at least one feed section for at least one further polymer and/or additives; a mixing section, in which the rubber particles, the at least one further polymer and the additives are mixed together to give a melt of the thermoplastic molding compound; and a discharge zone, through which a melt strand is extruded from the extruder.

Thermoplastic molding compounds that can be produced by the process are, in particular, molding compounds containing at least one rubber component, such as, in particular, acrylonitrile-styrene-acrylate copolymers (ASA) or acrylonitrile-butadiene-styrene copolymer (ABS) molding compounds. The production of such thermoplastic molding compounds is described for example in EP-A 0 734825, WO-A 2020/043690, WO-A 2015/000873 or WO-A 2015/004112.

For the production, in general, particulate rubbers, more particularly butyl acrylate-based graft rubbers or butadiene-based graft rubbers, are first prepared by emulsion polymerization in an aqueous system and then precipitated by means of a precipitation solution.

The resulting particles are then typically dewatered, for example by filtration, sieving, decanting, pressing out the water or centrifugation, optionally washed with water during the dewatering or subsequently and then optionally freed of further water by thermal drying. The particulate rubbers are then fed to an extruder and further dewatered, and then mixed with further components in the extruder and processed to the thermoplastic molding compound.

A disadvantage of all known processes is that both in the dewatering of the aqueous suspension containing rubber particles and in the dewatering of the rubber particles in the extruder, a liquid phase is produced which still contains up to 15% by weight of rubber, based on the sum of water and rubber, which is usually disposed of with the water that has been removed. Although it is generally known from WO 2015/000873 that the water removed can be returned to the operation, its direct recirculation may result in a situation in which rubber from the removed liquid phase can lead to deposits or blockages in downstream plant components. In addition, owing to the high rubber content in the water arising during dewatering in the extruder, deposits or blockages may even occur at the drain from the extruder.

It is accordingly an object of the present invention to provide a process for producing thermoplastic molding compounds which provides a better yield and in which the amount of the precipitant salt and product removed from the operation with the water can be minimized while simultaneously the risk of blockages in pipelines is minimized.

This object is achieved by a process for producing thermoplastic molding compounds, comprising:
(a) feeding a dispersion containing a rubber and also a precipitation solution into a precipitation vessel, to generate an aqueous suspension containing rubber particles,
(b) optionally sintering the rubber particles present in the aqueous suspension containing rubber particles, to give larger particles,
(c) mechanically dewatering the aqueous suspension containing rubber particles, to obtain rubber particles containing residual moisture and a liquid phase containing finely divided rubber,
(d) feeding the rubber particles containing residual moisture into an extruder, the extruder comprising an intake zone, into which the rubber particles containing residual moisture are fed; a dewatering section, in which a liquid phase containing residual rubber is removed from the rubber particles containing residual moisture; at least one feed section for at least one further polymer and/or additives; a mixing section, in which the rubber particles, the at least one further polymer and the additives are mixed together to give a melt of the thermoplastic molding compound; and a discharge zone, through which a melt strand is extruded from the extruder,
   wherein the liquid phase containing residual rubber that is removed in the dewatering section is collected in a buffer container, the buffer container comprising at least one stirrer with which the liquid phase containing residual rubber is stirred to prevent accumulation of the rubber particles still contained in the liquid, and returning the liquid phase containing residual rubber collected in the buffer container to the precipitating container.

Surprisingly, it has emerged that stirring the liquid phase containing the residual rubber in the buffer container is sufficient to reduce or even prevent blockage of pipelines through which the liquid phase containing residual rubber is passed.

It has also emerged that the repeated thermal loading of the rubber particles which are returned to the precipitating container with the liquid phase containing residual rubber-repeated owing to the precipitation and the sintering being performed at typically elevated temperatures-does not adversely affect the mechanical properties of the thermoplastic molding compound produced by the process. This means that the recirculation makes it possible to increase the yield of rubber while maintaining the same product quality, and at the same time the amount of rubber removed from the operation with the wastewater can be minimized. The amount of wastewater and thus also the amount of precipitant salt required are likewise minimized, while the precipitation and/or the sintering may be operated at the same time with reduced solids content, thereby reducing the risk of blockage in this process step.

The liquid phase containing residual rubber obtained in the dewatering section of the extruder usually contains more than 1% by weight of rubber, more preferably 3% to 20% by weight of rubber and more particularly 5% to 15% by weight of rubber.

Because of the fraction of rubber in the liquid phase containing residual rubber, there is a risk that deposits and/or blockages may form in the conduit between the dewatering section of the extruder and the buffer container. In order to prevent these deposits and/or blockages, it is preferred if the liquid phase containing residual rubber is mixed with water after removal from the extruder. The amount of water with which the liquid phase containing the residual rubber is mixed is preferably adjusted such that the liquid phase containing the residual rubber after addition of the water has a fraction of not more than 15% by weight of rubber, more preferably a fraction of rubber in the range from 2% to 12% by weight and more particularly a fraction of rubber in the range from 4% to 10% by weight.

In order to further increase the yield and minimize the amount of rubber that is removed from the operation with the wastewater, it is additionally preferred if the liquid phase containing finely divided rubber is returned to the precipitating container.

Since the rubber is the same in the liquid phase containing the finely divided rubber obtained on mechanical dewatering in step (c) and in the liquid phase containing the residual rubber arising in the dewatering section of the extruder in step (d), it is additionally preferred if the liquid phase containing the finely divided rubber, before being returned to the precipitating container, is introduced into the buffer container and mixed with the liquid phase containing residual rubber removed in the dewatering section. In this way, only one return conduit is required into the precipitating container and, depending on the production conditions, rubber-containing liquid can be returned in a targeted manner from the buffer container to the precipitating container. It is not necessary to match the liquid phase containing the finely divided rubber and the liquid phase containing the residual rubber when they are introduced into the precipitating container.

The rubber used in the process of the invention may be a grafted rubber. Preference is given to a rubber comprising one or more grafted-on shells of other, generally non-elastomeric, polymers. To this end, the single- or multi-stage elastomeric base stages are obtained by polymerization of one or more of the monomers butadiene, isoprene, chloroprene, styrene, alkylstyrene, C₁ to C₁₀ alkyl esters of acrylic acid or methacrylic acid and small amounts of other monomers, including crosslinking monomers, wherein the hard graft stages are polymerized from one or more of the following monomers: styrene, alkylstyrene, acrylonitrile, methyl methacrylate. It is also possible to produce the starting stage using a seed obtained on the basis of the monomers butadiene, isoprene, chloroprene, styrene, alkyl styrene, C₁- to C₁₀-alkyl esters of acrylic acid or methacrylic acid and small amounts of other monomers also including crosslinkable monomers.

Preferred rubbers are those based on: butadiene/styrene/acrylonitrile, n-butyl acrylate/styrene/acrylonitrile, butadiene/n-butyl acrylate/styrene/acrylonitrile, n-butyl acrylate/styrene/methyl methacrylate, butadiene/styrene/acrylonitrile/methyl methacrylate and butadiene/n-butyl acrylate/methyl methacrylate/styrene/acrylonitrile. Up to 10% by weight of polar monomers bearing functional groups or else crosslinking monomers may be incorporated in the seed and/or core and/or shell by polymerization.

Examples of the rubbers used in the process of the invention include polymers of conjugated dienes such as butadiene, having an external graft shell, especially based on a vinylaromatic compound, such as SAN copolymers, for example. The rubbers may also be rubbers based on crosslinked polymers of C₁- to C₁₀-alkyl esters of acrylic acid such as n-butyl acrylate or ethylhexyl acrylate grafted with polymers based on vinylaromatic compounds such as SAN copolymers. Additionally, the process is also suitable for graft rubbers which substantially contain a copolymer of conjugated dienes and C₁ to C₁₂ alkyl acrylates, a butadiene-n-butyl acrylate copolymer for example, and one or more graft stages composed of SAN copolymer, polystyrene or PMMA. Butadiene graft rubbers and butyl acrylate graft rubbers are particularly preferred.

The rubber is typically produced in an aqueous system, for example by emulsion polymerization as described for example in WO-A 2020/043690. Emulsion polymerization forms an aqueous dispersion with water as a continuous phase and rubber particles produced in the polymerization as a disperse phase.

For treatment the dispersion is introduced into a precipitating container. To convey the dispersion from the emulsion polymerization it is preferable to employ a peristaltic pump if the dispersion storage tank does not allow a sufficient gradient for pump-free gravity-fed addition.

The dispersion supplied to the precipitating container preferably has a solids content in the range from 10% to 50% by weight, more preferably from 20% to 45% by weight and particularly preferably from 30% to 40% by weight. The solid present in the dispersion is the rubber present in particulate form.

In the precipitating container, the dispersion is converted into an aqueous suspension containing rubber particles by addition of a precipitant salt solution preferably containing at least one salt and/or one acid.

In the context of the present invention, a dispersion is understood to be a mixture of particles having a volume-average particle diameter Dv of 20 to 999 nm, preferably in the range from 50 to 800 nm, in a liquid phase. The volume-average particle diameter Dv (or the average particle diameter according to De Broucker) is an average parameter based on the unit volume of the particles. The volume-average particle diameter of the particles in the dispersion may be determined for example by light scattering (laser diffraction), for example with a Beckman Coulter instrument.

The suspension is to be understood as meaning a mixture of particles in a liquid phase whose particles are greater than the particles of the dispersion. To determine the particle size of the suspension it is possible to use, depending on the type of determination of the particle size and the size distribution, for example the D10 value, the D50 value or the D90 value, wherein the D10 value specifies the particle size up to which 10% by weight of particles are smaller, the D50 value accordingly specifies the particle size up to which 50% by weight of particles are smaller and the D90 value specifies the particle size up to which 90% by weight of particles are smaller. The particles in the suspension typically have a D10 value in the range from 50 to 400 μm, a D50 value in the range from 200 to 2000 μm and/or a D90 value in the range from 500 to 4000 μm. The particles in the suspension particularly preferably have a D10 value of 50 to 400 μm, a D50 value of 200 to 2000 μm and a D90 value of 500 to 4000 μm. The particle size of the particles of the suspension is preferably determined by wet sieving which employs sieve towers comprising sieves of different mesh sizes. After sieving, the mass of the particles on the individual sieves is determined, thus making it possible to derive the D10 value, the D50 value and the D90 value.

The precipitation solution preferably contains a divalent salt or a trivalent salt and the precipitation solution especially contains at least one alkaline earth metal salt, preferably a magnesium salt and/or calcium salt, particularly preferably at least one magnesium salt.

The at least one alkaline earth metal salt is more particularly selected from alkaline earth metal halides, such as chlorides, alkaline earth metal sulfates, alkaline earth metal phosphates, such as orthophosphates or pyrophosphates, alkaline earth metal acetates and alkaline earth metal formates. The at least one alkaline earth metal salt is preferably selected from chlorides and sulfates.

Preferred alkaline earth metal salts are magnesium sulfate (such as kieserite (Mg[SO₄].H₂O), pentahydrite (Mg[SO₄].5H₂O), hexahydrite (Mg[SO₄].6H₂O) and epsom salts (Mg[SO₄].7H₂O)), magnesium chloride, calcium chloride, calcium formate, magnesium formate or mixtures thereof. Particular preference is given to the use of magnesium sulfate.

If the precipitation solution contains a trivalent salt, anhydrous aluminum sulfate or aluminum sulfate with water of crystallization are particularly preferred.

The amount of salt added depends on the amount of water present in the dispersion and is preferably in a range from 0.1% to 3% by weight, preferably in a range from 0.5% to 3% by weight and in particular in a range from 0.5% to 2% by weight of salt, in each case based on the amount of water in the dispersion.

The pH of the mixture of dispersion and precipitation solution obtained in step (a) is preferably in the range from 3 to 10. It is possible here to carry out the precipitation in the acidic range or in the basic range; in the case of precipitation in the acidic range, the pH of the mixture is preferably in the range from 3 to 7, in particular in the range from 4 to 6, and in the case of precipitation in the basic range, it is preferably in the range from 7 to 9 and in particular in the range from 8 to 9.

The pH may be adjusted for example by addition of buffer salts, acids and/or bases, for example using sulfuric acid, phosphoric acid, solutions of sodium hydroxide, potassium hydroxide, sodium salts and potassium salts of carbonates (for example sodium carbonate Na₂CO₃ and/or sodium hydrogencarbonate NaHCO₃ or mixtures thereof), sulfates or phosphates (for example tetrasodium pyrophosphate). It is preferable to add for example at least one buffer salt from the group of sodium salts, especially selected from the group of sodium carbonates, sodium sulfates and sodium phosphates, preferably from the group of sodium carbonates Na₂CO₃ and sodium hydrogencarbonates NaHCO₃.

The buffer salts, acids and/or bases may be added as early as during production of the rubber in the emulsion polymerization or admixed in the precipitating container in step (a). Preferably, the addition of buffer salts or bases is carried out during the production of the rubber in the emulsion polymerization. Acids are added in the precipitating container or immediately before introduction into the precipitating container.

To precipitate the rubber from the dispersion and obtain the aqueous suspension containing rubber particles the precipitant solution and the dispersion are typically mixed over a period in the range from 5 to 50 minutes, preferably 5 to 40 minutes.

The precipitation in step (a) may be carried out in a temperature range from 20 to 150° C., preferably from 40 to 100° C., particularly preferably from 45 to 99° C., likewise preferably from 60 to 95° C. The dispersion is preferably mixed with the at least one precipitation solution at a temperature in the range from 30 to 95° C., preferably 40 to 95° C., particularly preferably 40 to 90° C.

To obtain larger particles, the rubber particles present in the aqueous suspension containing rubber particles obtained in step (a) may be agglomerated to afford larger particles in a subsequent sintering step (b). To this end the aqueous suspension containing rubber particles obtained in step (a) is preferably conveyed to a sintering container in which the aqueous suspension containing rubber particles is held at a temperature in the range from 70 to 150° C., preferably in the range from 75 to 140° C. and particularly preferably in the range from 85 to 140° C. In particular, the aqueous suspension containing rubber particles is kept at this temperature for a period of 10 to 90 minutes, preferably 15 to 90 minutes, particularly preferably 15 to 80 minutes.

With particular preference, the mixing of the dispersion and the precipitation solution in step (a) is carried out at a temperature in the range from 30 to 95° C. and preferably in the range from 40 to 90° C. and, if step (b) is performed, the sintering in step (b) is carried out for at least 5 minutes at a temperature in the range from 70 to 150° C., preferably 80 to 140° C.

The precipitation of the rubber particles in step (a) and the sintering in step (b) may be performed in different vessels or in the same vessel, wherein precipitation and sintering in the same vessel is possible especially when the process is in batchwise operation since, in this case, initial mixing of the dispersion with the precipitant solution at relatively low temperature is followed by sintering of the rubber particles at relatively high temperature. It is therefore preferable when a precipitation vessel is used for step (a) and a sintering vessel is used for step (b), wherein the sintering vessel and the precipitation vessel are two different vessels. To transport the aqueous suspension containing rubber particles the sintering vessel and the precipitation vessel are connected with a connecting conduit which accommodates a pump.

To obtain the most uniform possible size distribution of the resulting agglomerated particles it is advantageous when both the precipitation of the rubber particles in the precipitation vessel and also the sintering are performed continuously. In order to keep the suspension containing the rubber particles in motion and to prevent sedimentation of the rubber particles, especially even when feeding the suspension to a subsequent plant component is not possible for example due to an outage, the connecting conduit between the precipitating container and the sintering container is provided with a pumped circulation circuit in which the aqueous suspension containing rubber particles is pump-circulated in a loop line.

For continuous operation it is further advantageous to make the sintering vessel larger than the precipitation vessel if the required residence time in the sintering vessel is greater than the residence time in the precipitation vessel.

After precipitation or, if step (b) is performed, after sintering the aqueous suspension containing rubber particles is dewatered to obtain rubber particles containing residual moisture and a liquid phase containing finely divided rubber.

The water content of the rubber particles containing residual moisture is preferably not more than 60% by weight, more preferably not more than 50% by weight and especially not more than 40% by weight, in each based on the total mass of the rubber particles containing residual moisture. Water content may especially be determined using suitable analytical instruments, for example drying and weighing apparatuses, wherein a sample is dried until a constant weight of the sample over a certain period is achieved. For example, the water content of the rubber particles containing residual moisture may be determined in a Halogen Moisture Analyzer HR73 from Mettler Toledo at 180° C. until attainment of constant weight for 30 seconds.

The water content of the rubber particles containing residual moisture obtained in step (c) is in particular in the range from 10% to 50% by weight, preferably in the range from 20% to 45% by weight and especially in the range from 20% to 40% by weight, in each case based on the total mass of the rubber particles containing residual moisture.

Mechanical dewatering is typically effected by continuous or batchwise centrifugation and/or filtration. Mechanical dewatering is preferably achieved by continuous centrifugation. To this end the aqueous suspension containing rubber particles is centrifuged for example at a centripetal acceleration of 200·g to 2000·g, where acceleration due to gravity g=9.81 m/s², preferably at a centripetal acceleration of 500·g to 1300·g, over a period of 1 second to 5 minutes, preferably of 1 to 120 seconds.

To prevent sedimentation of the rubber particles, especially in case of failure of a continuously operating mechanical dewatering, it is advantageous here too if the connection between sintering container and continuously operating mechanical dewatering, especially at least one centrifuge or at least one filtration apparatus, is provided with a pumped circulation circuit in which the suspension containing the sintered rubber particles is pumped in circulation in a loop conduit before it is fed to the centrifuge and/or the filtration apparatus.

If a discontinuously emptied batch centrifuge is employed, a stirrer-equipped buffer container for collecting the suspension containing the rubber particles is necessary.

The rubber particles containing residual moisture may then be washed with water and/or a mixture of water and a polar, water-miscible solvent and subsequently dried, as described for example in WO-A 2020/043690.

Since the liquid phase separated off in step (c) in the mechanical dewatering of the aqueous suspension containing rubber particles from the rubber particles containing residual moisture still contains finely divided rubber, the liquid phase containing the finely divided rubber is preferably returned to the precipitating container.

The residual moisture-containing rubber particles are then introduced into an extruder for the production of the thermoplastic molding compound, the extruder comprising an intake zone, into which the rubber particles containing residual moisture are fed; a dewatering section, in which a liquid phase containing residual rubber is at least partly removed from the rubber particles containing residual moisture; at least one feed section for at least one further polymer and/or additives; a mixing section, in which the rubber particles, the at least one further polymer and the additives are mixed together to give a melt of the thermoplastic molding compound; and a discharge zone, through which a melt strand is extruded from the extruder.

For example the extruder is constructed as described in WO 2015/004112 or WO 2015/000873.

The residual moisture-containing rubber particles are fed into the intake zone of the extruder by means of a metering device.

The dewatering section follows the intake zone and preferably contains at least one hold-up element and at least one associated drainage opening in each case, where the at least one drainage opening, as well as the drainage opening of the intake zone, is equipped preferably with a metal wire mesh composite plate, a fine-hole panel or a slotted screen. Alternatively or in addition, the at least one drainage opening may also be equipped with a stuffing screw. Preferably all the drainage openings are equipped with a stuffing screw.

In the feed section adjacent to the dewatering section, the further components of the thermoplastic molding compound are introduced preferably as a melt into the extruder.

The mixing section is provided with mixing, kneading and/or other plastifying elements, as they are commonly used in extruders.

A degassing section provided with at least one degassing opening may follow the mixing section; in the degassing section, further water or other components still contained in the thermoplastic molding compound as impurities are removed as vapor from the thermoplastic molding compound, and the degassing openings may be open or, for example, may be provided with a stuffing screw.

The end of the extruder is formed by the discharge zone, with a tool connected to the discharge opening of the discharge zone, through which the thermoplastic molding compound is discharged from the extruder.

The extruder used has at least one drainage opening, but may also have several drainage openings, for example two or three drainage openings. However, it is also possible that the extruder has very many more drainage openings, for example up to 30 drainage openings.

The drainage openings can be located at any point over the circumference of the extruder housing, for example at the top side, laterally or facing downward. It is also possible to arrange drainage openings in pairs opposite each other. Any other arrangement of the drainage openings is also conceivable. Stuffing screws can be fitted on the drainage openings.

Dewatering takes place generally with the conveying direction downstream of the intake zone. In the simplest case, there is only one drainage opening, which is arranged downstream of the intake zone.

The drainage openings can be configured in a manner known per se and correspond in their geometry to known openings, as they are usually also used for removing gaseous substances from an extruder. This allows drainage openings that are recesses and/or bores in the extruder housing to be used. As drainage openings, for example, circular bores or bores in the form of an eight, i.e., two directly adjacent circular bores, are suitable, wherein the longitudinal axis of the eight can be arranged, for example, at a right angle (transverse) or parallel (longitudinal) to the conveying direction of the extruder.

Alternatively, the drainage openings can also be rectangular, square or oval in form. The square or rectangular drainage openings can be implemented with rounded corners. If the extruder comprises more than one drainage opening, the individual drainage openings may also each have a different shape and/or size. The drainage openings can alternatively also be cut from the extruder housing in any shape, for example rectangular, and in this cutout an insert with the desired shape of the drainage opening can then be used; for example, the shape of an eight for the drainage opening is preferred in the case of attachment of a stuffing screw with a double screw.

The extruder is preferably operated such that the mean pressure in the region of the drainage openings is in the range from 10 to 55 bar, in particular in the range from 15 to 35 bar. Short-term pressure spikes can also exceed 55 bar. The pressure can be monitored with standard pressure gauges. The monitoring here may be based on direct measurement of the mechanical pressure or on measurement of the pressure on a membrane, a piezoelectric element, a sensor or other common components, such as those used by the skilled person in the technical monitoring of pressure.

The drainage openings can be operated under normal pressure, under vacuum or under overpressure, with all drainage openings able to have the same or different pressure. The moisture content of the extrusion material can be adjusted within certain limits at this point by means of corresponding overpressure or underpressure. With underpressure the absolute pressure is usually 2 to 900 mbar(abs), preferably 10 to 800 mbar(abs) and in particular 30 to 500 mbar(abs), and with overpressure a pressure between 1.1 and 20 bar(abs) is generally established. However, it is preferable to operate the dewatering under normal pressure or under vacuum. In operation under vacuum, the water is withdrawn in a gaseous and non-liquid form. Therefore, the withdrawal openings operated under vacuum are also referred to as degassing openings. In contrast, the drainage openings denote those openings through which the water is withdrawn in liquid form.

The closing of the drainage openings with the metal wire mesh composite plate, the fine-hole panel or the slotted screen or the attaching of the stuffing screw largely prevents the rubber being discharged from the extruder together with the water through the drainage opening.

However, it is not possible to prevent some of the rubber leaving the extruder with the water through the drainage openings. Usually, the residual rubber-containing liquid phase, which is withdrawn from the extruder via the drainage openings, still contains more than 1% by weight of rubber, more preferably 3% to 20% by weight of rubber and more particularly 5% to 15% by weight of rubber, respectively based on the total mass of the residual rubber-containing liquid phase.

In order to minimize the amount of rubber removed from the operation, according to the invention, the liquid phase containing residual rubber and separated off in the dewatering section is collected in a buffer container.

To prevent the rubber particles still present in the liquid phase from accumulating—that is, in the case of a rubber having a density greater than the density of the liquid phase, sedimenting and, in the case of a rubber having a density lower than the density of the liquid phase, floating—the buffer container comprises at least one stirrer, with which the liquid phase containing residual rubber is stirred.

For reuse, the liquid phase containing residual rubber and collected in the buffer container is returned to the precipitating container.

The buffer container may be any container equipped with a stirrer, provided the stirrer can be operated such that the accumulation of the rubber particles can be prevented. Suitable stirrers that can be used in the buffer container are, for example, propeller stirrers.

Owing to the relatively high fraction of rubber in the residual rubber-containing phase withdrawn from the extruder through the drainage openings, it is preferred to mix the residual rubber-containing liquid phase with water after removal from the extruder, to prevent deposits and/or blockages in the conduit between the extruder and the buffer container into which the liquid phase containing residual rubber is introduced. The water here is preferably introduced continuously or discontinuously, directly after the drainage opening, into the liquid phase containing the residual rubber. However, the addition can also take place at any other point in the conduit between the extruder and the buffer container, with addition directly after the drainage opening being particularly preferred.

The amount of water added to the liquid phase containing the residual rubber is preferably chosen such that the liquid phase containing the residual rubber after addition of the water still contains not more than 15% by weight of rubber, more preferably 2% to 12% by weight of rubber and more particularly 4% to 10% by weight of rubber, respectively based on the total mass of the residual rubber-containing liquid phase.

It has emerged that the water added after the drainage openings in combination with the stirring of the liquid phase containing the residual rubber in the buffer container is sufficient to reduce or even prevent blockage of pipelines through which the liquid phase containing residual rubber is passed.

The water that is added to the liquid phase containing residual rubber can be, for example, fresh water, in particular fully demineralized water (demineralized water).

Since it cannot be ruled out that the amount of residual rubber-containing liquid phase fed to the buffer container is greater than the amount of residual rubber-containing liquid phase withdrawn from the buffer container—for example, if the production and processing of the rubber has to be interrupted but operation of the extrusion is continued—it is preferable if the buffer container has an overflow that allows the liquid phase containing residual rubber to be discharged from the operation as wastewater. Because of the rubber contained in the wastewater, it is necessary to treat it in a suitable plant before the wastewater can be discharged into the environment or fed to another operation as service water.

The further polymer or further polymers which are fed to the extruder in the further-polymer feed section adjacent to the dewatering zone depend on the thermoplastic molding compound to be produced.

Preferably, the thermoplastic molding compound which is produced with the process of the invention is a butyl acrylate-styrene-acrylonitrile copolymer, an acrylonitrile-butadiene-styrene copolymer or an acrylonitrile-styrene-acrylate copolymer.

Therefore, thermoplastic polymers fed in the further-polymer feed section are preferably polymers selected from styrene-acrylonitrile copolymers (SAN), polystyrene (PS), polymethyl methacrylate (PMMA), or mixtures thereof.

Preference here is given to SAN polymers, PMMA or mixtures of these polymers. In addition, thermoplastic polymers that are fed to the feed section adjacent to the dewatering zone can also be polycarbonates (PC), polyalkylene terephthalates such as polybutylene terephthalate (PBT) and polyethylene terephthalate (PET), polyoxymethylene (POM), polyphenylene sulfide (PPS), polysulfones (PSU), polyethersulfones (PES), polyamides (PA) or mixtures of these thermoplastic polymers. Thermoplastic elastomers such as thermoplastic polyurethane (E-TPU) can also be used, moreover.

In addition, the thermoplastic polymer fed to the feed section adjacent to the dewatering section may also use a copolymer based on styrene/maleic anhydride, styrene/imidized maleic anhydride, styrene/maleic anhydride/imidized maleic anhydride, styrene/methyl methacrylate/imidized maleic anhydride, styrene/methyl methacrylate, styrene/methyl methacrylate/maleic anhydride, methyl methacrylate/imidized maleic anhydride, styrene/imidized methyl methacrylate, imidized PMMA or mixtures of these polymers.

In all of the stated styrene-containing thermoplastic polymers, some or all of the styrene can be replaced by alpha-methylstyrene or by ring-alkylated styrenes or by acrylonitrile. Of the latter thermoplastic polymers, those based on alpha-methylstyrene/acrylonitrile, styrene/maleic anhydride, styrene/methyl methacrylate and copolymers with imidized maleic anhydride are preferred.

In the further sections of the extruder which adjoin the feed section for at least one further polymer, the supplied components are conventionally melted, mixed, homogenized, de-gassed if necessary and extruded as a melt strand from the extruder. The melt strand can then be chopped into pellets, for example.

For buffering of fluctuations in throughput in the individual process steps, it is preferable if the liquid phase containing the finely divided rubber is initially run into a return water container before it is passed back to the precipitating container. This also makes it possible to control the amount of liquid phase containing finely divided rubber which is admixed with the dispersion in the precipitation vessel in order for example to establish a desired content of solid in the mixture of the dispersion from the emulsion polymerization supplied to the precipitation vessel and the liquid phase containing the finely divided rubber.

Since the amount of finely divided rubber in the liquid phase containing the finely divided rubber is only very low and generally not more than 2% by weight and especially in the range from 0.01% to 1% by weight in each case based on the total mass of the liquid phase containing the finely divided rubber, it is further preferable when the recycled water vessel is a settling vessel in which a rubber-rich phase and a low-rubber phase are formed. The rubber-rich phase may be the upper phase or the lower phase depending on the density of the rubber.

To prevent the liquid phase present in the return water container from being stirred up and intermixed by introduction of further liquid phase containing finely divided rubber and also to prevent foaming in the return water container, it is preferable if the liquid phase containing the finely divided rubber is introduced into the return water container via a dip pipe. Especially if the return water container is a settling container, this can prevent the incipient rubber-rich phase and incipient low-rubber phase from being intermixed again.

The rubber-rich phase can be passed back from the return water container directly into the precipitating container. The content of rubber in the low-rubber phase is preferably not more than 0.5% by weight, more preferably in the range from 0.001% to 0.1% by weight and especially preferably in the range from 0.001% to 0.07% by weight, in each case based on the total mass of the low-rubber phase.

Since the water of the recycled rubber-rich phase contains not only the finely divided rubber but also dissolved salt and/or acid from the precipitation solution fed into the precipitating container, it is further preferable if the rubber-rich phase passed back directly into the precipitating container is combined, before introduction into the precipitating container, with the precipitation solution likewise introduced into the precipitating container. Mixing the precipitation solution with the returned rubber-rich phase before introduction into the precipitating container has the further advantage that the formation of undesirably large rubber particles due to local high concentrations of the precipitation solution in the precipitation vessel and to very rapid precipitation can be prevented.

The salt content may be determined for example by a conductivity measurement or by titration, the acid content may be determined via pH determination and the flow rates may be determined in each case by providing a suitable flowmeter known to the skilled person in the conduits upstream of the mixing site. In order to adjust the desired concentration of salt and/or acid for the precipitation, the mass streams of the supplied precipitation solution and of the returned rubber-rich phase are determined separately and the desired amount of precipitation solution is added using a ratio control means.

In order to also recover the rubber from the low-rubber phase and not to send it for disposal with the wastewater, the low-rubber phase is preferably concentrated and then fed to the precipitating container.

The wastewater formed during the concentration is sent for disposal, where the wastewater amount preferably corresponds to the amount of water supplied with the dispersion and the precipitation solution minus the amount of water removed at other points from the operation, especially the water still present in the rubber particles containing residual moisture. This makes it possible to achieve a continuous operation without the amount of water in the operation continually increasing due to recycled water.

Any process known to the skilled person for separating solids from a solids-containing liquid may be utilized to concentrate the rubber particles present in the low-rubber phase. It is particularly preferable if the rubber particles are concentrated from the low-rubber phase with a filtration. Filtration of the low-rubber phase produces a rubber-rich retentate and a substantially rubber-free filtrate, and the rubber-rich retentate is recycled to the precipitating container.

The filtration of the low-rubber phase may be operated continuously. In this case, the low-rubber phase is concentrated by pressing fluid through the filter as it flows through the filtration apparatus. This results in a rubber-rich retentate that is returned to the precipitating container and a substantially rubber-free filtrate that can be disposed of as wastewater. For the adjustment of the rubber content in the retentate, the volume flow through the filter, the pressure difference across the filter and/or the filter surface area can be adapted, for example. It is possible here to use only one filter or two or more filters, in which case the filters can be connected in parallel and/or in series.

Alternatively and preferably, however, the filtration is operated such that the rubber contained in the low-rubber phase accumulates as a filter cake on the filter of the filtration apparatus and the liquid is removed from the filter as a substantially rubber-free filtrate. In this case, the resulting filter cake is flushed discontinuously with demineralized water or filtered return water into the precipitating container.

Filters that can be used to concentrate the rubber from the low-rubber phase are, for example, edge gap filters. For example, edge gaps are suitable as filter material, wherein the gap dimension of the filter is preferably in the range from 10 to 500 μm, more preferably in the range from 50 to 250 μm and in particular in the range from 75 to 200 μm.

During filtration, solids are usually deposited on the filter, forming a filter cake. Depending on the volume flow rate of the low-rubber phase which is passed through the filter apparatus, at least a part of the filter cake can be washed from the filter with the low-rubber phase, in which the rubber accumulates during filtration, and returned with the retentate to the precipitating container.

If a filter cake is formed that cannot be washed off with the retentate, it is preferable to wash the filter regularly. The time at which the filter is washed may be determined for example by the increase in the necessary pressure difference required to press the filtrate through the filter. Even if the filtration is performed such that the rubber from the low-rubber phase is separated so as to form a filter cake, the accordingly resulting filter cake is regularly washed from the filter as described above and the washing liquid with the rubber present therein is returned to the precipitating container.

If a filter is utilized which does not require application of positive pressure on the retentate side and/or negative pressure on the filtrate side the time at which washing of the filter becomes necessary may also be determined by means of the filtrate volume flow or the solids content in the retentate.

Washing of the filter may be achieved by passing a washing liquid through the filter from the filtrate side to the retentate side, thus washing the filter cake from the filter. It is alternatively also possible to supply the washing liquid to the filter instead of the low-rubber phase. Since the filter cake contains substantially rubber, it is preferable if the washing liquid comprising the rubber from the filter cake present therein is introduced into the precipitating container. To allow the washing liquid comprising the rubber present therein to be introduced to the precipitating container it is preferable to employ a washing liquid containing only such components as are also present in the liquid in the precipitating container. It is therefore particularly preferable to employ water as the washing liquid.

The substantially rubber-free filtrate is removed from the operation and preferably supplied to a wastewater treatment before the wastewater is discharged to the environment. Alternatively, the substantially rubber-free filtrate can also be added in place of the fresh water described above, in particular demineralized water, or together with fresh water downstream of the drainage openings to the residual rubber-containing liquid phase.

If the amount of liquid phase containing finely divided rubber that is supplied to the return water container from the mechanical dewatering is greater than the amounts of rubber-rich phase and low-rubber phase withdrawn from the return water container, with the result that the fill level in the return water container may exceed a maximum fill level, the return water container preferably comprises an overflow via which a wastewater stream may be discharged from the return water container.

If the rubber has a lower density than the liquid, it floats in the return water container, with the result that the rubber-rich phase is found in the upper region of the return water container. In this case the overflow is therefore preferably arranged in the lower region of the return water container in order ideally to withdraw only low-rubber phase in the event that the fill level in the return water container exceeds a maximum fill level. To allow the liquid to be discharged without providing an additional valve, it is therefore preferable when the conduit forming the overflow initially runs upward up to the height of the maximum fill level and there comprises a bend of at least 90°, so that the low-rubber phase can be discharged via the overflow on account of the hydrostatic pressure only once the maximum fill level is reached.

The rubber will correspondingly sink if it has a density higher than that of the liquid. In this case the rubber-rich phase is at the bottom of the return water container and the low-rubber phase is at the top, so that when the overflow is arranged in an upper region of the return water container, preferably at the position of the maximum fill level, low-rubber phase flows into the overflow when the fill level in the return water container gets excessively high.

Especially when using the return water container in a swing plant which produces both rubber having a lower density and rubber having a higher density than the liquid, it is preferable to arrange an overflow at the top of the return water container, preferably at the position of the maximum fill level, and to have an overflow at the bottom of the return water container, where in the case of a rubber having a density lower than the density of the liquid the overflow at the top of the return water container is closed and in the case of a rubber having a density higher than the density of the liquid the overflow at the bottom of the return water container is closed. It is further preferable if the overflow at the bottom is connected via a conduit with the overflow at the top of the return water container, wherein the conduit opens into the overflow downstream of a shutoff member and the opening of the conduit into the overflow is preferably at the same height as the connection of the overflow to the return water container.

Once the fill level in the return water container exceeds the maximum filling level, rubber-rich phase flows into the overflow. To prevent the rubber-rich phase, which then flows into the overflow, from passing to a wastewater disposal, thus resulting in loss of the rubber contained in the rubber-rich phase, it is in this case preferable to provide a recycle conduit which branches from the overflow and opens into the conduit through which the low-rubber phase flows for concentration, especially filtration. This makes it possible to prevent the liquid withdrawn from the overflow, which still contains rubber, from being sent for disposal and thus the rubber present therein from being removed from the operation as waste.

The liquid phase containing residual rubber collected in the buffer container can either be returned directly to the precipitating container or alternatively introduced into the return water container. In the second case, the liquid phase containing residual rubber is mixed with the phase containing the finely divided rubber, which arises during the mechanical dewatering of the aqueous suspension containing rubber particles. To prevent the liquid phase contained in the return water container from being stirred up and mixed by introduction of the liquid phase containing residual rubber, and further to prevent foaming in the return water container, it is preferable if the phase containing residual rubber is fed into the conduit through which the liquid phase containing finely divided rubber is introduced into the return water container.

As an alternative to the use of a return water container, it is also possible to introduce the liquid phase containing the finely divided rubber which arises during mechanical dewatering of the aqueous suspension containing rubber particles into the buffer container before it is returned to the precipitating container and to mix it with the liquid phase containing residual rubber that is removed in the dewatering section. This has in particular the advantage that the solids content in the buffer container is lowered by introduction of the finely divided rubber-containing liquid phase into the buffer container, whereby the tendency to form deposits or blockages, in particular in the connecting line from the buffer container into the precipitating container, is further reduced.

Irrespective of whether the liquid phase containing the finely divided rubber is introduced into the buffer container and mixed therein with the liquid phase containing the residual rubber, the liquid phase containing residual rubber and collected in the buffer container is first introduced into the return water container or the liquid phase containing the finely divided rubber from the return water container and the liquid phase containing the residual rubber from the buffer container are each separately introduced into the precipitating container, it is preferred if the liquid phase containing residual rubber that is returned from the buffer container to the precipitating container and/or the liquid phase containing finely divided rubber or the mixture of the liquid phase containing the finely divided rubber and liquid phase containing residual rubber is mixed with the precipitation solution prior to introduction into the precipitating container.

As a pump with which the liquid phase containing the sintered rubber particles or, if the separate sintering step has not been carried out, the suspension containing rubber particles obtained in step (a) is conveyed into the mechanical dewatering, a centrifugal pump configured as a vortex pump is preferably used. As a pump with which the low-rubber phase is conveyed into the filtration, an eccentric screw pump is preferably used.

Owing to the fraction of solids in the liquid phase containing residual rubber which is introduced into the buffer container and then returned from the buffer container either to the return water container or directly into the precipitating container, it is likewise preferred to use a centrifugal pump configured as a vortex pump.

If the buffer container is arranged below the extruder, it is possible for the water discharged through the drainage opening to flow directly into the buffer container. In this case, it is not necessary to use a pump for transport from the extruder into the buffer container. A separate pump is also not required to transport the liquid phase containing residual rubber into the buffer container if the pressure at which the liquid phase containing residual rubber exits the extruder is greater than the pressure in the buffer container.

For the transport of the aqueous suspension containing rubber particles and/or for the transport of the rubber-rich phase and/or for the transport of the residual rubber-containing liquid phase, a centrifugal pump configured as a vortex pump is preferably used. A preferred centrifugal pump has an open or semi-open impeller, where the impeller is a radial wheel which has a large passage for the solids contained in the conveying medium. In addition, such an open or semi-open impeller is the least susceptible to faults when used for conveying liquids containing particles.

The use of an eccentric screw pump or a centrifugal pump configured as a vortex pump therefore allows the transport of the liquid phase containing the rubber particles without the pump being able to be blocked by the rubber particles contained in the liquid phase, since a sufficiently large flow channel is included which can be traversed by the flow of liquid without contact with the impeller of the pump.

In order to prevent wear or blocking of the eccentric screw pump through swelling of the plastic owing to residual monomers that are possibly still contained, and thus to enable uniform delivery of the liquid phase containing the rubber particles, it is further preferred if the stator and/or rotor of the eccentric screw pump are made of chlorosulfonated polyethylene rubber (CMS), available for example as Hypalon® from DuPont Performance Elastomers, or are coated therewith. Alternatively, it is also possible to fabricate the stator and/or rotor of the eccentric screw pump from a metal—for example, from steel or aluminum. It is particularly preferred if either the stator or the rotor is made of CMS and the other part is made of a metal.

Since the rubber particles continue to agglomerate with increasing residence time and thus become larger, it is further preferred if the particle size of the rubber particles precipitated in step (a) and/or of the rubber particles sintered in step (b) or of the liquid phase containing the residual rubber can be controlled. For this purpose it is possible, for example, to use a pump containing a cutting tool for particle shredding and/or to connect a particle shredder upstream of the pump.

Suitable particle shredders are, for example, wet grinding machines, which are traversed by the flow of the liquid phase containing the rubber particles and which usually contain cutting tools, where the cutting tools can be rigidly contained in the particle shredder or can be configured as rotor and stator. Suitable particle shredders are Siefer Trigonal® machines, for example.

Pumps that contain rotor-stator toothed mixing elements for particle shredding are available, for example, under the name Supraton® inline homogenizers from BWS Technologie GmbH.

An exemplary embodiment of the invention is shown in the figure and is explained in more detail in the following description.

The single figure shows a flow diagram of the method of the invention.

For the treatment of rubbers from a dispersion containing the rubber, the dispersion 1 which contains the rubber and which, for example, derives from an emulsion polymerization is introduced into a precipitating container 5, together with a precipitation solution 3. The dispersion 1 here is preferably conveyed into the precipitating container 5 solely through gravity. Should conveying by gravity be impossible, especially if the dispersion storage tank in which the dispersion is intermediately stored is too low, the dispersion 1 is preferably conveyed into the precipitating container 5 with a peristaltic pump.

In the precipitating container, the dispersion 1 containing the rubber and the precipitation solution 3 are intermixed with a mixing unit 7, a stirrer for example, to form an aqueous suspension containing rubber particles. The aqueous suspension 9 containing rubber particles is removed from the precipitating container and supplied to an optional sintering container 11 in which the rubber particles agglomerate to afford larger particles. To prevent settling of the rubber particles, the suspension containing rubber particles present in the sintering container 11 is likewise intermixed using a mixing unit 13, a stirrer for example.

To convey the aqueous suspension 9 containing the rubber particles from the precipitating container 5 into the sintering container 11, a first pump 15 is accommodated in the conduit connecting the precipitating container 5 and the sintering container 11. Preferably, the first pump 15 is part of a pumped circulation circuit 17, in which in particular in the event of failure of the removal from the sintering container 11, for example in the event of failure of plant components downstream of the sintering container, the rubber particle-containing suspension 9 is kept in motion and so sedimentation of the particles is prevented. The first pump 15 is in this case preferably a centrifugal pump configured as a vortex pump.

The suspension 18 now containing larger rubber particles is supplied from the sintering container 11 to a mechanical dewatering 19. The mechanical dewatering 19 here can be carried out for example by centrifugation or filtration, with centrifugation being preferred. To drain the sintering container 11, a drain conduit 20 is preferably provided at the bottom of the sintering container.

In normal operation, the drain conduit 20 is closed and the aqueous suspension 18 containing larger rubber particles produced in the sintering container is removed via the withdrawal conduit at the head of the sintering container 11.

In particular in the case of batchwise mechanical dewatering 19, it is necessary for the aqueous suspension containing rubber particles that is supplied to the mechanical dewatering 19 to be intermediately stored. A buffer container 21, for example, in which the aqueous suspension 18 containing rubber particles is intermediately stored may be provided to this end. To prevent rubber particles sedimenting out of the suspension, it is preferable if the buffer container 21 comprises a mixing unit, a stirrer for example, with which the suspension can be stirred.

Alternatively or in addition it is further preferable to provide, as shown here, a second pumped circulation circuit 23 in which the aqueous suspension containing rubber particles may be pump-circulated. The aqueous suspension containing rubber particles is intermixed in the second pumped circulation circuit 23 in order to prevent precipitation of the rubber particles. The second pumped circulation circuit 23 is advantageous especially when the mechanical dewatering is performed continuously.

If the mechanical dewatering 19 is operated continuously, it is sufficient to provide the second pumped circulation circuit 23, though the buffer container 21 may alternatively or in addition be connected upstream of the mechanical dewatering 19.

If the mechanical dewatering 19 is operated batchwise, the buffer container 21 is necessary to intermediately store the suspension before the latter is supplied to the mechanical dewatering 19. However, it is possible here too, as shown in the figure, to connect the pumped circulation circuit 23 upstream of the buffer container 21.

Both for the transport of the aqueous suspension containing rubber particles from the sintering container 11 into the mechanical dewatering 19 and for the circulation in the pumped circulation circuit 23, a second pump 25 is accommodated in the pumped circulation circuit 23. It is further preferable to provide a bypass 27 which makes it possible to circumvent the second pump 25, with a third pump 29 being accommodated in the bypass 27.

Alternatively to the embodiment shown here, the second pump 25 and the third pump 29 may also be connected in series. This is advantageous especially when the third pump 29 cannot build up a sufficiently high pressure relative to the second pump 25, since in this case a circular flow from the pressure side to the suction side would be established.

It is preferable when the second pump 25 and the third pump 29 are a centrifugal pump configured as a vortex pump, similarly to the first pump 15.

Since the particles can further agglomerate in the pumped circulation circuit 23, it is further preferable if the second pump 25 and/or the third pump 29 are equipped with a cutting device for particle comminution. Use of the cutting device allows the particle size of the rubber particles to be adjusted to a desired size and particles attaining an undesired size due to agglomeration are comminuted. Especially when the suspension 18 containing rubber particles is conveyed directly into the mechanical dewatering 19 it is preferable when the second pump 25 and the third pump 29 are connected in series, where in this case the second pump 25 preferably does not contain a cutting device and establishes the necessary pressure and the third pump 29 having a cutting device is connected downstream of the second pump. If a buffer container 21 is present, no significant pressurization is necessary and the second pump 25 and the third pump 20 can run in parallel.

Alternatively or in addition to a pump having a cutting device, the pumped circulation circuit 23 may also accommodate a particle shredder which prevents formation of excessively large rubber particles. This particle shredder is preferably a wet grinding apparatus.

The sintering of the rubber particles in the sintering container 11 is generally carried out at a temperature above the temperature at which the mechanical dewatering 19 is performed. It is therefore preferable to provide a heat exchanger 31 in the connection conduit from the sintering container 11 to the mechanical dewatering 19 to cool the aqueous suspension containing rubber particles. If a pumped circulation circuit 23 is provided between the sintering container 11 and the mechanical dewatering 19, the heat exchanger 31 is preferably located at a position in the pumped circulation circuit through which the aqueous suspension containing rubber particles flows even when said suspension is introduced directly from the sintering container 11 into the mechanical dewatering 19 and does not flow in a circuit in the pumped circulation circuit. When using a buffer container 21, it is also possible alternatively to temperature-condition the buffer container 21 with a cooling, for example by means of a double jacket or cooling pipes running in the buffer container.

In the mechanical dewatering 19, the rubber particles are separated from the aqueous suspension containing rubber particles, and rubber particles 33 containing residual moisture and a liquid phase 35 containing finely divided rubber are obtained.

The liquid phase 35 containing finely divided rubber is introduced into a return water container 37. The return water container 37 is preferably a settling container in which the finely divided rubber from the liquid phase containing the finely divided rubber accumulates, thus forming a rubber-rich phase and a low-rubber phase.

The fraction of rubber in the rubber-rich phase 39 is preferably high enough that the rubber-rich phase may be withdrawn directly from the return water container 37 and recycled into the precipitating container 5.

In order to pass the rubber-rich phase 39 from the return water container 37 into the precipitating container 5, a pump 41 may be accommodated in the connection conduit from the return water container 39 to the precipitating container 5. However, it is preferable if the return water container 37 is positioned higher than the precipitating container 5, so that the rubber-rich phase 39 can flow into the precipitating container 5 purely under gravity, thus obviating the need for the pump 41.

It is further preferable if the recycled rubber-rich phase 39 is mixed with the precipitation solution 3 before introduction into the precipitating container 5.

In order to obtain the rubber contained in the low-rubber phase 43 as a product as well, and not to dispose of it with the wastewater from the operation, the low-rubber phase 43 is fed from the return water container 37 to a filtration 45. The filtration 45 concentrates the rubber from the low-rubber phase, thus forming a rubber-rich retentate 47 that is introduced into the precipitating container 5.

If the filtration 45 is performed such that a filter cake is formed on the filter in the filtration apparatus, said cake is preferably regularly washed off and the washing solution with the rubber present therein is introduced into the precipitating container 5 as rubber-rich retentate 47. In order not to introduce any unwanted components into the precipitating container 5, the backwashing is preferably carried out with water, in particular with fully demineralized water 49. It is alternatively possible to employ filtrate 51 for backwashing.

The pore size of the filter used for the filtration 45 is preferably selected such that substantially all of the finely divided rubber present in the low-rubber phase is separated off, so that a substantially rubber-free filtrate 51 is formed which can be discharged as wastewater and supplied to a wastewater treatment and then sent for disposal.

A fourth pump 53 is preferably used to convey the low-rubber phase 43 into the filtration 45. It is possible here to employ any pump capable of conveying a liquid phase containing only a low solids fraction. Suitable pumps are, for example, centrifugal pumps or eccentric screw pumps. When using an eccentric screw pump, it is particularly preferred if the stator and/or the rotor of the eccentric screw pump are made of chlorosulfonated polyethylene rubber (CMS).

The residual moisture-containing rubber particles 33 withdrawn from the mechanical dewatering 19 are fed to an intake zone 55 of an extruder 57 for the production of a thermoplastic molding compound, in particular of ABS or ASA. The residual moisture-containing rubber particles are passed via the intake zone, with development of pressure, into a dewatering section 59 of the extruder 57. In the dewatering section 59, further water is squeezed from the residual moisture-containing rubber particles and introduced via at least one drainage opening 61 into a buffer container 63.

In order to prevent the conduit leading from the drainage opening 61 into the buffer container 63 from becoming blocked, it is preferred if water is introduced continuously or discontinuously into this conduit. Preferably, the water is introduced directly after the drainage opening 61. The water can be fresh water, in particular fully demineralized water, or the filtrate 51 which arises in the filtration 45 can be fed in.

The dewatered rubber particles are supplied to a feed section 65 for at least one further polymer and/or additives, with the feed section 65 for producing the thermoplastic molding compound being fed in particular with a thermoplastic polymer 67, for example SAN copolymer.

In a mixing section 69 which is adjacent to the feed section 65, the thermoplastic polymer is mixed with the rubber and homogenized to give the thermoplastic molding compound.

The mixing section 69, at the beginning and end of which there may be degassing openings, is followed by a discharge zone 71, from which the thermoplastic molding compound 73, preferably in the form of a melt strand which can then be chopped into pellets, is discharged. With particular preference the thermoplastic molding compound is an ABS copolymer or an ASA copolymer.

Since the liquid phase supplied to the buffer container 63 still contains residual rubber, the buffer container 63 has a stirrer 75 with which the residual rubber is held in suspension in the liquid phase and accumulation of the residual rubber is prevented. Depending on whether a rubber is used that has a density lower than the density of the liquid or a rubber with a density greater than the density of the liquid, the rubber may float or sediment if the liquid phase containing the residual rubber in the buffer container 63 is not stirred.

From the buffer container 63, the residual rubber-containing liquid phase 77 is returned to the precipitating container 5. In this case, it is particularly preferred if the liquid phase 77 containing the residual rubber is mixed with the precipitation solution 3 prior to introduction into the precipitating container 5. For this purpose, as shown here, both the rubber-rich phase 39 and the residual rubber-containing liquid phase 77 may be introduced at different positions into a feed line for the precipitation solution 3, or two separate feed lines for the precipitation solution 3 may be provided, in which case the rubber-rich phase 39 is introduced into one feed line and the phase 77 containing residual rubber into the other.

It is also possible, moreover, to mix the rubber-rich phase 39 and the residual rubber-containing phase 77 before mixing them with the precipitation solution 3.

In addition to the variants described above, it is also possible, alternatively, to introduce the residual rubber-containing phase 77 not into the precipitating container 5 but into the return water container 37. In this case, the residual rubber-containing phase 77 and the finely divided rubber-containing liquid phase 35 are directly combined in the return water container 37. If the residual rubber-containing phase 77 is to be introduced into the return water container 37, it is particularly preferred if the residual rubber-containing phase 77 is introduced into the liquid phase 35 containing the finely divided rubber before this is introduced into the return water container 37. In particular, unwanted eddies at the liquid surface in the return water container 37 can be avoided in this way. If the residual rubber-containing phase 77 is introduced directly into the return water container 37, it is preferred if it is introduced via a dip tube into the return water container 37 in the same way as the finely divided rubber-containing liquid phase 35.

For conveying the residual rubber-containing liquid phase 77, a pump 79 is preferably provided which is implemented as a centrifugal pump configured as a free-flow pump. In particular, a centrifugal pump is used here which has an open or semi-open impeller to prevent blocking of the pump 79.

To prevent the buffer container 63 from being unable to absorb further liquid phase containing residual rubber from the dewatering section 59—for example, if the extrusion is still being operated but the precipitation has to be interrupted and so no residual rubber-containing liquid phase 77 can be passed into the precipitating container 5—the buffer container 63 preferably has an overflow 81.

When a maximum filling level is reached, liquid phase containing residual rubber can run off from the buffer container 63 via the overflow.

In this case, the residual rubber-containing liquid phase which runs off via the overflow 81 is usually disposed of as waste water after appropriate treatment.

1-15. (canceled)

16. A method for producing thermoplastic molding compounds, comprising:
(a) feeding a dispersion containing a rubber and a precipitation solution into a precipitating container, to generate an aqueous suspension containing rubber particles;
(b) optionally sintering the rubber particles contained in the aqueous suspension containing rubber particles, to give larger particles;
(c) mechanically dewatering the aqueous suspension containing rubber particles, to obtain rubber particles containing residual moisture and a liquid phase containing finely divided rubber; and
(d) feeding the rubber particles containing residual moisture into an extruder,
wherein the extruder comprises:
an intake zone, into which the rubber particles containing residual moisture are fed;
a dewatering section, in which a liquid phase containing residual rubber is removed from the rubber particles containing residual moisture;
at least one feed section for at least one further polymer and/or additives;
a mixing section, in which the rubber particles containing residual moisture and the at least one further polymer and/or additives are mixed together to give a melt of the thermoplastic molding compound; and
a discharge zone, through which a melt strand is extruded from the extruder,
wherein the liquid phase containing residual rubber that is removed in the dewatering section is collected in a buffer container, and
wherein the buffer container comprises at least one stirrer with which the liquid phase containing residual rubber is stirred to prevent accumulation of the rubber particles still contained in the liquid; and
(e) returning the liquid phase containing residual rubber collected in the buffer container to the precipitating container.

17. The method of claim 16, wherein the method further comprises returning the liquid phase containing finely divided rubber to the precipitating container.

18. The method of claim 16, wherein the method further comprises mixing the liquid phase containing residual rubber with water after removal from the extruder.

19. The method of claim 17, wherein the method further comprises introducing the liquid phase containing finely divided rubber into the buffer container and mixing the liquid phase containing finely divided rubber introduced into the buffer container with the liquid phase containing residual rubber that was removed in the dewatering section before returning the liquid phase containing finely divided rubber to the precipitating container.

20. The method of claim 16, wherein the method further comprises mixing the liquid phase containing residual rubber returned from the buffer container to the precipitating container and/or the liquid phase containing finely divided rubber with the precipitation solution before introducing the liquid phase containing residual rubber and/or the liquid phase containing finely divided rubber into the precipitating container.

21. The method of claim 16,
wherein the buffer container comprises an overflow, and
wherein the method further comprises discharging the liquid phase containing residual rubber as waste water via the overflow.

22. The method of claim 17, wherein the method further comprises collecting the liquid phase containing finely divided rubber in a return water container.

23. The method of claim 22,
wherein the return water container is a settling container, and
wherein the method further comprises forming a rubber-rich phase and a low-rubber phase in the settling container.

24. The method of claim 23, wherein the method further comprises mixing the rubber-rich phase with the precipitation solution before introducing the rubber-rich phase into the precipitating container.

25. The method of claim 23, wherein the method further comprises concentrating the low-rubber phase and returning the low-rubber phase to the precipitating container.

26. The method of claim 22, wherein the method further comprises introducing the liquid phase containing residual rubber collected in the buffer container into the return water container.

27. The method of claim 25, wherein the method further comprises recirculating the liquid phase containing residual rubber from the buffer container, the liquid phase containing finely divided rubber, the rubber-rich phase, and/or the concentrated low-rubber phase using an eccentric screw pump or centrifugal pump configured as a vortex pump.

28. The method of claim 27,
wherein the vortex pump comprises a stator and/or rotor, and
wherein the stator and/or the rotor are made of chlorosulfonated polyethylene rubber.

29. The method of claim 16, wherein the rubber is a graft butyl acrylate rubber or a graft butadiene rubber.

30. The method of claim 16, wherein the thermoplastic molding compound is a copolymer selected from the group consisting of a butyl acrylate-styrene-acrylonitrile copolymer, an acrylonitrile-butadiene-styrene copolymer, or an acrylonitrile-styrene-acrylate copolymer.
